(19) United States
(12) Patent Application Publication
(10) Pub. No.: US 2012/0192954 A1
(43) Pub. Date: Aug. 2, 2012

(54) ROTATING DISC VALVE

(75) Inventor: Roger Jorgenson, Swanton, OH (US)

(73) Assignee: RED LION BIO-ENERGY TECHNOLOGIES, Maumee, OH (US)

(21) Appl. No.: 13/018,260

(22) Filed: Jan. 31, 2011

(51) Int. Cl. F17D 3/03; F16K 1/34

(52) U.S. Cl. 137/2; 251/210

(57) ABSTRACT

Systems and methods are provided facilitating control of material flow. A valve comprises a rotating disc, wherein the rotating disc further comprises at least one hole and one closure surface to facilitate opening and closing a material flow path. In an open state a hole is positioned in the flow path, in a closed state a closure surface is placed in the flow path. Further, sacrificial components are included in the valve to reduce the effects of wear. Furthermore, wear of the sacrificial components can be determined without having to disassemble the valve.

### TECHNICAL FIELD

The subject disclosure relates to a rotating disc valve apparatus which can operate as a gate valve, and employable to control material flow.

### BACKGROUND

Gate valves find application in materials handling and materials transportation systems and are employed to control material flow by opening or closing, both completely or partially, a material flow path. Issues concerning materials handling pertain to a variety of materials, where such materials may comprise of one or a plurality of phase states such as solid, semi-solid, liquid, semi-liquid, gaseous, etc.

As shown in FIG. 12, during operation of a gate valve, blade 1210 is raised/lowered to open or close flow of the material through the valve opening 1220 and ultimately through the section(s) of the transportation system being regulated by the gate valve. Typically the working edge 1230 of the blade 1210 mates with the internal surface 1240 of the valve body 1250 to facilitate closure of the valve and termination of material flow through the valve. As the working edge 1230 of the blade 1210 moves away from the valve body mating surface 1240, flow of the material is enabled, with the position of the blade 1210 with respect to the opening 1220 in which the blade operates, facilitating partial or complete opening of flow path 1220.

Operation of a gate valve when transporting solids can result in solid material being entrapped between the working edge 1230 of the blade 1210 and the mating surface 1240 of the valve resulting in incomplete closure of the gate valve, as shown in the FIG. 12, partially closed depiction, portion 1260. The partial closure may be acceptable in a system, for example, carrying only solid material, wherein the opening may be of sufficiently small size that passage of any further material may be prevented. However, where the material comprises a combination of small and large particles/pieces, a large piece may be trapped but passage of smaller particles may still be possible through the unblocked portion of opening 1260. In a further example, the material being transported may comprise of a plurality of phase states, e.g., a solid/gaseous mix. In this example, a solid may be trapped in the valve opening 1260 but gas can still flow through the opening 1260 thereby leading to incomplete closure of the valve. Such partial closure and associated effects, e.g., gas leakage, can result in process being out of control and/or potentially hazardous.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In one embodiment, the present invention presents a gate valve to facilitate throughput of material in an environment which can include high temperature, high pressure and high duty cycle. Further, the gate valve can be employed to control a variety of materials, whether liquid, gaseous, semi-solid, abrasive, etc.

In an embodiment, the gate valve comprises a rotating disc which further comprises at least one hole and one closure surface. During operation of the valve, the rotating disc is rotated such that a hole is located between a valve inlet and a valve outlet thereby facilitating flow of material along a material flow path M-M between the valve inlet and the valve outlet. Flow of material along the material flow path M-M is terminated by rotating the rotating disc thereby positioning a closure surface between the valve inlet and the valve outlet. Repeated rotation of the rotating disc facilitates subsequent opening and closing of the valve by appropriate positioning of the at least one hole, or the at least one closure surface in the material flow path M-M between the valve inlet and the valve outlet.

In another embodiment, the rotating disc can comprise of a plurality of holes separated by an equivalent plurality of closure surfaces. For example, a rotating disc can have formed therein three holes and three closure surfaces. To facilitate sequential valve opening and valve closing, the rotating disc is to be advanced 60° between each respective hole and closure surface.

In an embodiment, rotation of the rotating disc is facilitated by a motor rotating a drive shaft, which via a pinion gear and a rack gear running around the circumference of the rotating disc, transmits rotational motion to the rotating disc. In a further embodiment, rotation of the rotating disc is in a rotational plane, N, aligned perpendicularly to the material flow path M-M.

In a further embodiment, to facilitate maintenance of the valve and prevent wear to the valve housing (e.g., comprising a top plate and a bottom plate) and wear to the rotating disc, sacrificial plates and discs are located on the valve housing and the rotating disc to separate the rotating disc from the valve housing. In an embodiment, the rotating disc can be sandwiched between a top disc wear plate and a floating disc wear plate to prevent exposure of the rotating plate bottom and top surfaces to opposing surfaces which can result in wear of the rotating disc. In another embodiment the internal surfaces of the respective bottom and top plates comprising the valve housing can have located respectively thereon a top seat disc and a floating seat disc. The top seat disc is located against the top disc wear plate of the rotating disc, and the floating seat disc is located against the floating disc wear plate thereby confining wear inside the valve housing to any of the top seat disc, the top disc wear plate, the floating seat disc, and/or the floating disc wear plate.

In an embodiment, compressive pressure can be applied to the floating seat disc to cause the floating seat disc, floating disc wear plate, rotating disc, top disc wear plate and top seat disc to be pressed against the internal surface of the top plate of the valve housing. The top plate of the valve housing includes a valve inlet through which material flows into the valve. By maintaining compressive pressure on the floating seat disc to cause the floating seat disc, floating disc wear plate, rotating disc, top disc wear plate and top seat disc, gaps between the respective mating surfaces of the respective discs and plates are kept to a minimum thereby preventing ingress of material between a plate and/or disc pairing.

In a further embodiment, the compressive pressure can be provided by springs located between the bottom plate of the valve housing and the floating seat disc. In another embodiment, the compressive pressure can be of such magnitude to compensate and/or overcome weight effects resulting from alignment of operation of the valve. For example, the valve can be employed in a variety of orientations with respect to the material flow path M-M such as the valve can be operated suspended and orientated such that flow path M-M is vertical.

In an embodiment, the rotating disc can be located on, and rotate about, a pivot shaft. The pivot shaft can include one or more indexes facilitating determination of the location of respective holes and closure surfaces comprising the top disc wear plate, floating disc wear plate and the rotating disc in relation to the valve inlet and valve outlet holes, e.g., material flow path M-M. The indexes can be employed to indicate whether a hole or a closure surface is located in the flow path M-M as well as enabling prediction of whether a hole or a closure surface will be positioned in the flow path M-M upon subsequent rotation of the rotating disc. In an embodiment, index position can be determined by a position sensor, where such sensor can be a proximity sensor. Signals generated by the position sensor can be received by a controller which can control operation of the motor, and accordingly the rotation of the rotating disc, based upon the received signals and desired valve operation.

In another embodiment, a vacuum can be provided to the valve to facilitate operation in a process requiring vacuum operation.

In another embodiment, the position of the pivot shaft, on which the rotating disk is located, can be determined. For instance, during operation of the valve, the position of the pivot shaft can be re-measured and based thereon the degree of wear to components comprising the valve can be determined without having to dismantle the valve. In an embodiment, by monitoring the change in position of the end of the pivot shaft, wear to components comprising the valve, e.g., top seat disc and the top seat disc wear plate, can be determined.

In a further embodiment, cooling can be incorporated into various valve components to prevent damage to heat sensitive components owing to adverse effects of heat transport during valve operation.

These and other embodiments are described in more detail below.

### BRIEF DESCRIPTION OF THE DRAWINGS

Various non-limiting embodiments are further described with reference to the accompanying drawings in which:

FIG. 1 is an exploded view of an exemplary, non-limiting embodiment depicting a plurality of components comprising a valve for controlling material throughput in accordance with one or more embodiments;

FIG. 2 an exemplary, non-limiting illustration presenting an angled view of an assembled valve system for controlling flow of material input in direction M in accordance with one or more embodiments;

FIG. 3 is an exemplary, non-limiting schematic representation of respective hole and closure surface location for components comprising a valve in accordance with one or more embodiments;

FIG. 4 is an exemplary, non-limiting illustration of a pivot shaft and location of position indexes thereon in accordance with one or more embodiments;

FIG. 5 presents exemplary, non-limiting illustrations of top, side and diagonal elevation views of a cap employed on a valve in accordance with one or more embodiments;

FIG. 6 is an exemplary, non-limiting illustration of a system facilitating control of material flow along a flow path in accordance with one or more embodiments;

FIG. 7 is an exemplary, non-limiting illustration of a system facilitating measurement of component wear in accordance with one or more embodiments;

FIG. 8 is an exemplary, non-limiting illustration of a system facilitating cooling of components in accordance with one or more embodiments;

FIG. 9 is a flow diagram illustrating an exemplary, non-limiting embodiment for controlling flow of material along a flow path in accordance with one or more embodiments;

FIG. 10 is a flow diagram illustrating an exemplary, non-limiting embodiment for facilitating wear to sacrificial components and maintaining internal pressure on components comprising a valve in accordance with one or more embodiments;

FIG. 11 is a flow diagram illustrating an exemplary, non-limiting embodiment for determining the degree of wear sustained by components comprising a valve in accordance with one or more embodiments; and

FIG. 12 illustrates operation of a gate valve.

### DETAILED DESCRIPTION

Described herein is a rotating disc valve (hereinafter “valve”) apparatus which can operate as a gate valve, wherein the valve can be employed to control material flow along a material flow path M-M.

In one embodiment, operation of the valve can be in conjunction with a batch-like feed operation. For example, the valve is open for a determined period of time/throughput of material, whereupon termination of the period the valve is closed. The feedstock passed through the valve can be subsequently processed, downstream of the valve, during which time the valve remains closed. When the next batch of feedstock is required, the valve is re-opened (e.g., the valve is rotated to the next “open” position, as described herein) and batch-like feed operation is conducted once more, etc.

In an alternative embodiment the valve can be employed in a system that requires a subsequent operation to be isolated from a total system. For example, the subsequent system may require a high degree of maintenance and requires isolation from any previous operations. Alternatively, the subsequent system may have a plurality of operation states and requires isolation from the previous system while the subsequent system adjusts from one operating state to another. A valve can be placed at the start of the subsequent operation, and upon closure, enables the subsequent operation to be isolated from any preceding operations.

It is to be appreciated that while throughout the description to aid understanding of the various innovative aspects presented herein particular examples are provided, the examples should not be considered limiting. For example, while a pressure of about 50 PSIG and an operating temperature of about 2000° F. is presented as particular operating conditions in which the valve may be employed to control material throughput, operating conditions (e.g., pressures, vacuum, partial vacuum, temperatures, throughput material composition and structure, etc.) can depart from these conditions while still facilitating utilization and operation of the valve. Selection of particular valve dimensions, construction materials, etc., can be based on various operating parameters such as the physical properties of the construction materials, operating conditions such as temperature and pressure, throughput material (e.g., material phase—gas, liquid, solid, semi-solid, slurry, etc., abrasive qualities of the material, particulate/particle size, etc.) and the like. Accordingly, while an operating pressure of a process being controlled by a valve may in one instance be about 50 PSIG, in another production run the pressure can be about 100 PSIG. In a first application an operating temperature of 2000° F. may be encountered, while in a second application an operating temperature of 1000° F. may be encountered, for example.

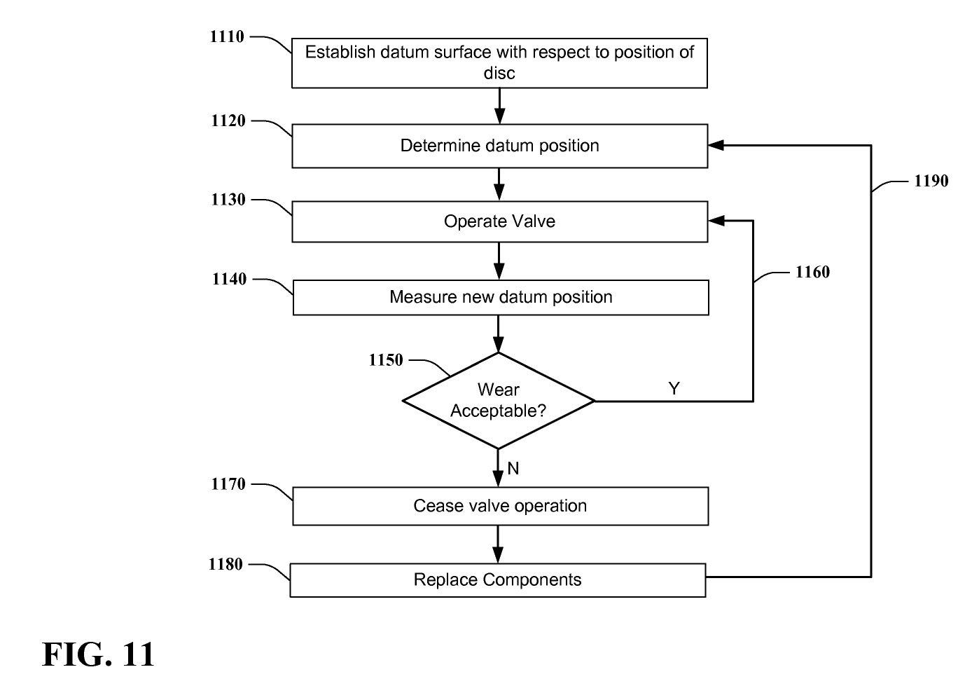

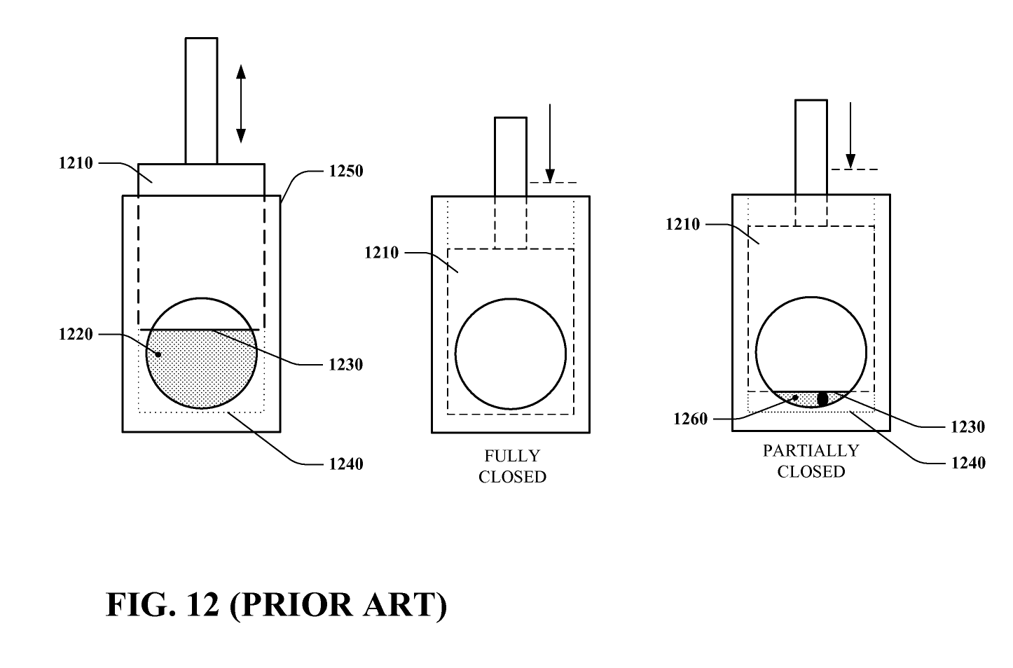

A particular application for one or more embodiments of a valve, as described herein, is in a plant producing syngas from biomass and other carbonaceous materials (e.g., coal, pet coke, municipal solid waste, and the like). As part of syngas production, biomass, and the like, is fed into a pyrolyser to produce gaseous elements and compounds which can be captured to form syngas. A by-product of the pyrolysis process is the decomposed biomass which can be in the form of ash, where depending upon the stage of the process, the ash can be of a high temperature and also continuing to outgas gaseous elements and compounds. The ash can be further processed to extract gaseous elements and compounds which may not have been released during a previous pyrolysis operation or the ash may be extracted from the pyrolyser for subsequent processing, e.g., forming into briquets. Ash can be in many forms ranging from fine particles in the form of a fine dust and powder through to sizeable lumps of material. Further, the ash can include abrasive material, whether formed as a by-product of a pyrolysis operation, resident in the original biomass feed stock, or entering the syngas process from another source/operation. Furthermore, various stages involved in syngas production can include temperatures upto and in the region of 2000° F. and pressures upto and in the region of 100 PSI. Hence, a conventional gate valve, as presented in FIG. 11 may not be suitable to control the transport of ash. In one aspect a piece of ash may become entrapped in 1160 thereby preventing full closure of the gate valve. In another aspect, the abrasive nature of ash and its constituents can lead to excessive wear of the blade 1110, blade edge 1130, housing 1150 and blade locating face 1140.

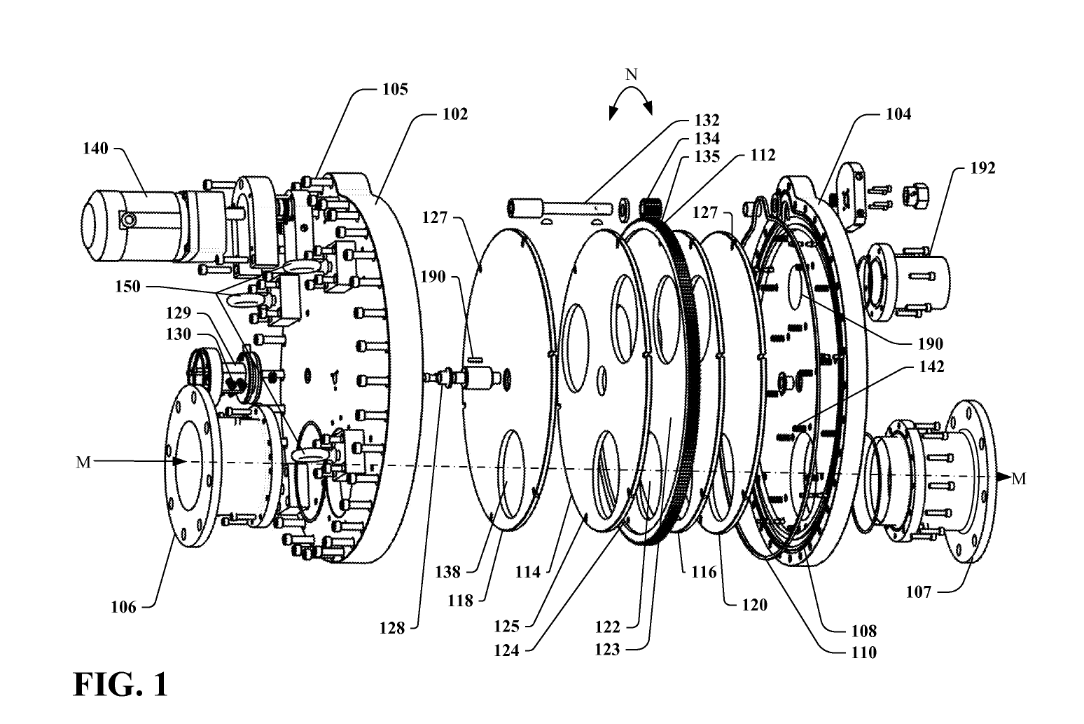

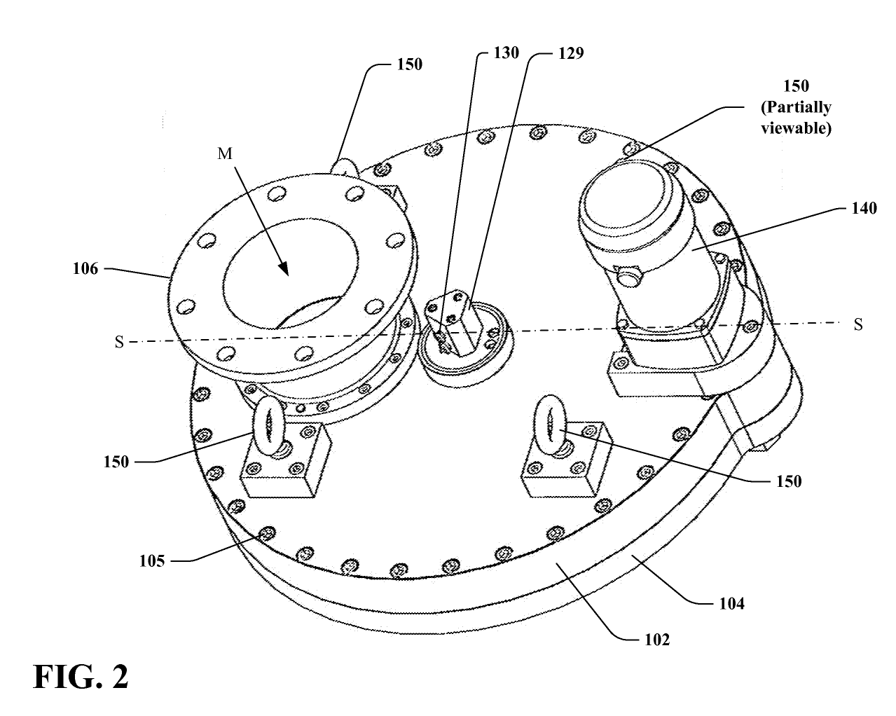

FIGS. 1 and 2 are illustrations of exemplary, non-limiting embodiments of a rotating disc valve assembly facilitating control of material flow along flow path M-M. FIG. 1 illustrates an exploded view of various components comprising a valve assembly. FIG. 2 illustrates a top-down angled view of an assembled valve showing various components which can be located on the exterior of the valve assembly. As shown in FIGS. 1 and 2, the main body of the valve comprises a top plate 102 which is fastened, by fasteners 105, to a bottom plate 104 to form a valve housing. Top plate 102 and bottom plate 104 can be manufactured from any material suitable for application in the control of material flow, e.g., carbon steel, stainless steel, etc., to facilitate suitable operation of the valve under the encountered operating conditions. Any suitable fasteners 105 may be employed, e.g., the fasteners 105 are threaded bolts which mate with threaded holes formed in bottom plate 104. During operation of the valve, feed stock enters the valve via inlet 106 and exits via outlet 107 along the material flow path M-M.

To facilitate pressure tight sealing of the valve housing, the top plate 102 and the bottom plate 104 have formed therein grooves (groove 108 is shown in the bottom plate 104) facilitating location of a gasket 110, or other suitable means for sealing the top plate 102 and bottom plate 104 mating face(s). Gasket 110 can be of any suitable material/form, e.g., an O-ring, spiral wound gasket, and the like, as required by the operating conditions in which the valve is employed and/or operating requirements of the valve. It is to be appreciated that any suitable means for sealing can be employed to facilitate sealing of two or more surfaces as required to enable prevention of leakage of the valve either to the atmosphere or from the atmosphere in which the valve is employed.

Further, the top plate 102 and bottom plate 104 have a recess formed therein such that when the top plate 102 and bottom plate 104 are assembled the valve housing thereformed has an internal cavity within which are located various components comprising a valve assembly, e.g., rotating disc 112, top disc wear plate 114, floating disc wear plate 116, top seat disc 118, floating seat disc 120, pivot shaft 128, springs 142, etc.

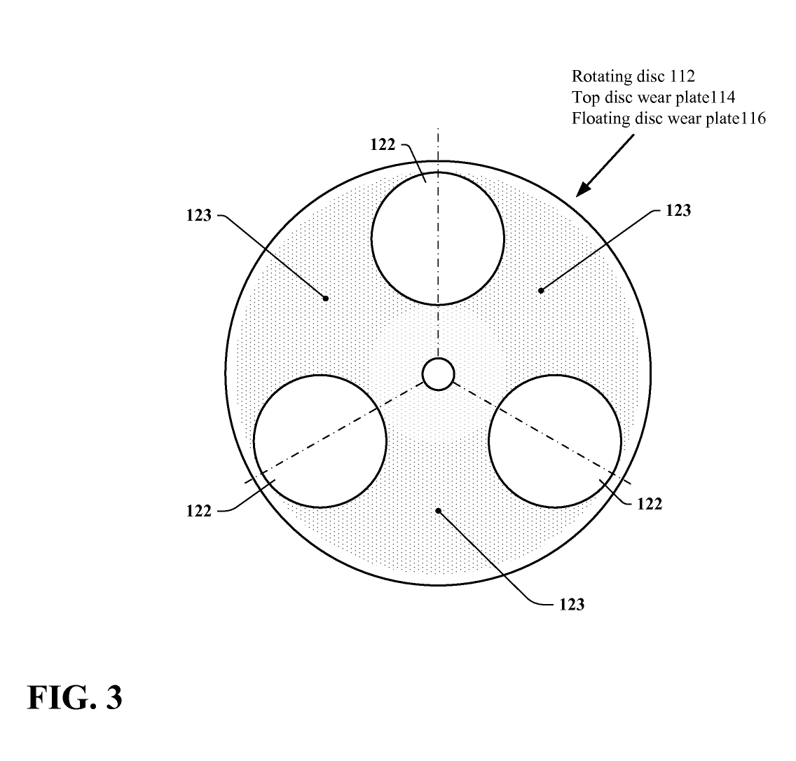

In an embodiment, rotating disc 112 is a ring gear comprising a plurality of holes 122 separated by closure surfaces 123. In the example illustrated in FIG. 1, three holes 122 are depicted, however any number of holes can be formed therein. As shown in FIG. 3, an exemplary, non-limiting schematic representing general layout of any of rotating disc 112, top disc wear plate 114 and/or floating disc wear plate 116, the three holes 122 are located 120° apart, with three closure surfaces 123 located therebetween, however any number of holes can be formed therein as described further below.

Referring once more to FIG. 1, on the top and bottom surfaces of the rotating disc 112 are respectively located top disc wear plate 114 and floating disc wear plate 116. To facilitate location of top disc wear plate 114 and floating disc wear plate 116, the position of the respective wear plate, top disc 114 or floating disc 116, with respect to the rotating disc 112, is maintained by a plurality of tongue 124 and groove 125 arrangements located on the respective inner/outer peripheries of the rotating disc 112, top disc wear plate 114 and floating disc wear plate 116. Tongue 124 locates in groove 125 enabling movement of the top disc wear plate 114 and/or floating disc wear plate 116 laterally (i.e., in any direction along axis M-M) with respect to the rotating disc 112, but not in the rotational direction N of rotating disc 112. The tongue 124 and groove 125 arrangement facilitates alignment of the three common holes 122 with respect to the rotating disc 112, the top disc wear plate 114 and floating disc wear plate 116, thereby allowing material to pass through an aligned hole 122. Any suitable material can be employed to manufacture the rotating disc 112, top disc wear plate 114 and floating disc wear plate 116, for example hardened tool steel, ceramic, cast iron, etc.

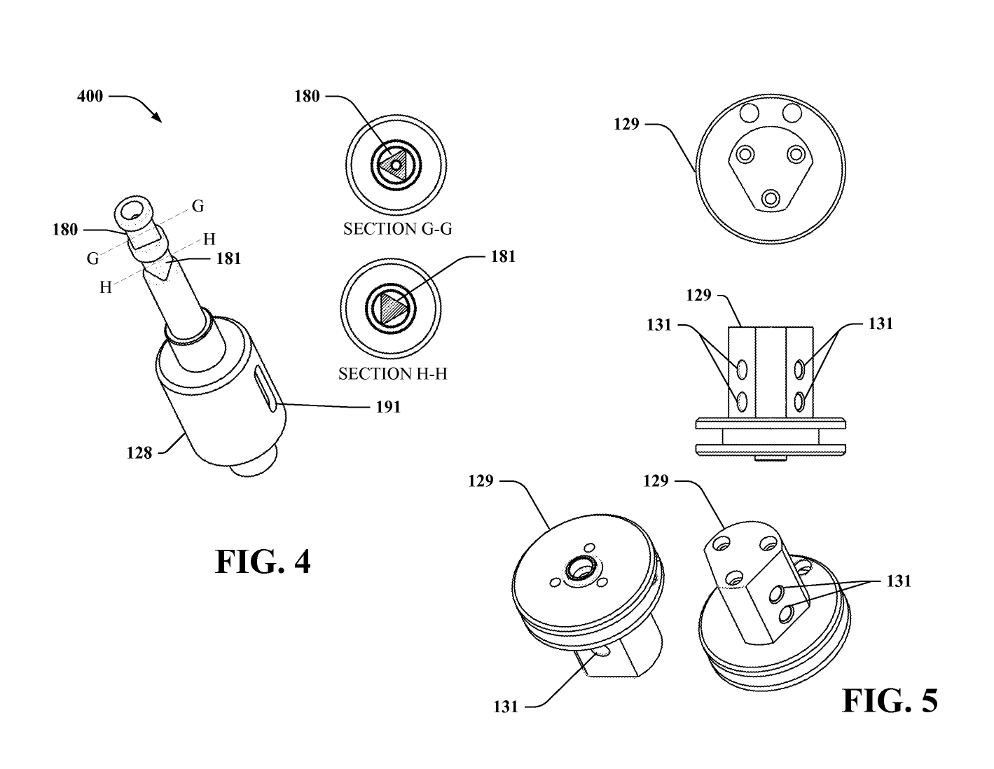

Rotating disc 112, top disc wear plate 114 and floating disc wear plate 116 are located onto, and rotate in conjunction with, a pivot shaft 128, where any suitable means for location can be employed between the pivot shaft 128 and the center-hole of the rotating disc 112 (and if required, top disc wear plate 114 and floating disc wear plate 116), such as a key 190 and keyway 191 (ref. FIG. 4) arrangement. The pivot shaft 128 extends into the top plate 102 and is located therein using any suitable bushing/bearing means, for example, a bronze bushing which is press fitted into the top plate 102, and the like.

As shown in FIGS. 1 and 2, the pivot shaft 128 can have a cap 129 externally located thereon. As shown in exemplary, non-limiting illustrations FIGS. 4 and 5, the position of the respective holes 122 formed in the rotating disc 112, top disc wear plate 114 and floating disc wear plate 116 can be determined by one or more indexes located on the end of the pivot shaft 128 operating in conjunction with proximity sensors 130 located in cap 129. As shown in FIG. 4, in an embodiment, pivot shaft 128 can comprise two indexes, 180 and 181, aligned in accordance with the position(s) of hole 122 respective to the alignment of the pivot shaft 128. Alignment can be provided by appropriate location of a keyway 191 on the pivot shaft 128, a keyway (not shown) in the center-hole of the rotating disc 112 and a key located therein to align keyway 191 with the keyway in the center-hole of the rotating disc 112, where such alignment is in accordance with the positions of respective holes 122.

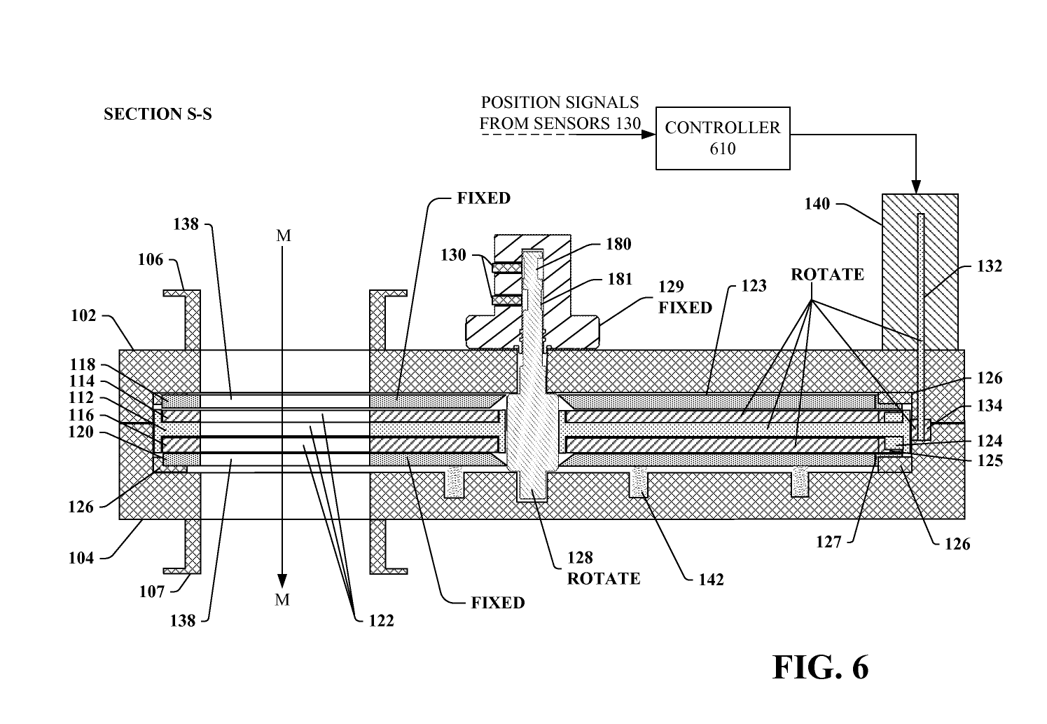

In an embodiment, the flat surfaces of indexes 180 and 181 can correlate respectively to the positions of the holes 122 and closure surfaces 123. As the pivot shaft 128 rotates during opening and closing of the valve, proximity sensors 130 (ref. FIG. 1 or 2) located in holes 131 of the cap 129 detect the change in distance between the surface(s) of indexes 180 and 181 and the proximity sensors 130. Binary signals (e.g., valve open, valve closed) generated by the proximity sensors 130 can be monitored from which the respective position of holes 122 and closure surfaces 123 can be determined. In one embodiment, signals from the proximity sensors 130 (e.g., valve open, valve closed) can be employed by a control system (ref. FIG. 6, controller 610) to control a motor 140 (ref. FIG. 1 or 2) employed to facilitate rotation of the rotating disc 112, as described below.

As mentioned, in an embodiment, rotating disc 112 is driven by a motor 140 mounted to the external side of top plate 102. Mechanical motion of the motor 140 is transferred to rotating disc 112 via a drive shaft 132 and pinion gear 134, where the pinion gear 134 meshes with gear teeth 135 which run around the circumference of the rotating disc 112. The type of gearing employed with the pinion gear 134 and gear teeth 135, to facilitate transmission of rotation to the rotating disc 112, can be helical, double helical, spur, etc. As motor 140 turns, accordingly, drive shaft 132 and pinion gear 134 rotate, rotational motion is transferred to gear teeth 135 causing rotation of the rotating disc 112, top disc wear plate 114 and floating disc wear plate 116, thereby facilitating movement of hole(s) 122 and closure surface(s) 123 with respect to the material flow path M-M.

An example of operation, according to an embodiment, can be as follows. In a first position, indexes 180 and 181, and signals from proximity sensors 130 indicate that the rotating disc 112 (with top disc wear plate 114 and floating disc wear plate 116 located thereon) is positioned to facilitate flow of material along the material flow path M-M, e.g., a hole 122 in each of rotating disc 112, top disc wear plate 114 and floating disc wear plate 116 are located between inlet 106 and outlet 107. When flow path M-M is required to be closed, motor 140 (via drive shaft 132, pinion gear 134, and gear teeth 135) drives the rotating disc 112 to a closed position, e.g., a closure surface 123 (e.g., of top disc wear plate 114) is positioned in material flow path M-M, terminating material flow along flow path M-M. During the next operation of material flow rotating plate 112 is rotated to an open position, as indicated by signals obtained from the proximity sensors 130. It is to be appreciated that while indexes 180 and 181 in the above embodiment are illustrated as comprising surfaces acting in a binary fashion for determination of the location of a hole 122 with respect to a material flow path M-M, where the binary operation is one of valve open or valve closed, in a further embodiment, an index can be employed having a plurality of index states allowing the position of rotating disc 112, top disc wear plate 114 and floating disc wear plate 116 and respective holes 122 and closure surfaces 123, to be known such that a hole 122 or closure surface 123 can be positioned to facilitate partial opening/closure of a material flow path M-M. Such plurality of index states is facilitated by further index surfaces being provided on pivot shaft 128 corresponding to valve half open, valve quarter open, etc., wherein indexes 180 and 181, rather than each comprising three index surfaces comprise the required number, e.g., six index surfaces.

In various embodiments, pivot shaft 128 can serve a plurality of purposes. As described above, pivot shaft 128 can act as a centering device for rotating disc 112 and rotation of the rotating disc 112 turns the pivot shaft 128 enabling location of respective hole(s) 122 and closure surfaces 123 to be known or predicted. In another embodiment, a pivot shaft 128 can be employed to indicate a degree of wear affecting rotating disc 112, top disc wear plate 114, and/or floating disc wear plate 116. Indication of wear using the pivot shaft 128 is further described below. In an embodiment pivot shaft 128 is located in a recess formed in the bottom plate 104, with a bushing or other similar means, providing location, e.g., for maintaining concentricity.

Referring to FIG. 1, separating the top disc wear plate 114 from the top plate 102 is top seat disc 118 and separating floating disc wear plate 116 from bottom plate 104 is floating seat disc 120. Top seat disc 118 comprises a single hole 138 which is aligned with respect to the material flow path M-M between feed inlet 106 and feed output 107. To prevent rotation of the top seat disc 118 with respect to the top plate 102, i.e., to prevent rotation of top seat disc 118 and thereby closing the material flow path M-M, top seat disc 118 is located with respect to the feed path of top plate 102 by a plurality of tongue 126 (ref. FIG. 6) and groove 127 arrangements located on the respective inner/outer peripheries of the top plate 102 and top seat disc 118, where the tongue and groove operation is of a similar manner to tongue 124 and groove 125, preventing rotation of the top seat disc 118 with respect to the top plate 102 (i.e., direction N) but enabling the top seat disc 118 to move laterally (i.e., back and forth along axis M-M) with respect to the top plate 102. Similarly, tongue and groove arrangements can be utilized to radially fix location of floating seat disc 120 with respect to bottom plate 104 such that hole 138 in the floating seat disc 120 is continually aligned with the feed path M-M in bottom plate 104 and outlet 107. Accordingly, floating seat disc 120 can move laterally (i.e., back and forth along axis M-M) with respect to bottom plate 104 but not radially, i.e., along axial direction N. Such application of tongue and groove arrangements, as employed between the respective pairings of top plate 102 and top seat disc 118, rotating disc 112 and top disc wear plate 114, rotating disc 112 and floating disc wear plate 116, and floating seat disc 120 and bottom plate 104, enables simple removal and replacement of any of the components, e.g., plates or discs 112, 114, 116, 118 and/or 120 where removal and replacement may be required as a result of one or more discs or plates 112, 114, 116, 118, and/or 120 being worn beyond an acceptable level.

In an embodiment, located between floating seat disc 120 and bottom plate 104 are a plurality of springs 142. The springs 142 provide a required pressure facilitating pressing of the floating seat disc 120 against an opposing surface of the floating disc wear plate 116. When system 100 is assembled, as shown in FIG. 2, springs 142 provide sufficient force to maintain contact between the respective contact surfaces of floating seat disc 120, floating disc wear-plate 116, rotating disc 112, top disc wear plate 114, and top seat disc 118. Further, in an embodiment, springs 142 can provide necessary force to facilitate operation of a valve. For example, when a valve is employed in a vertical arrangement (e.g., material flow path M-M is vertical) springs 142 located in bottom plate 104 can also provide the necessary compressive force to overcome any effects resulting from such operating alignment, e.g., the weight of the of the rotating disc 112, top disc wear plate 114, floating disc wear plate 116, top seat disc 118, and floating seat disc 120, etc. In effect, springs 142 are designed to maintain compressive pressure on floating seat disc 120, floating disc wear-plate 116, rotating disc 112, top disc wear plate 114, and top seat disc 118, and hence during operation of the valve, springs 142 provide sufficient force to maintain a pressure tight seal between the floating seat disc 120, floating disc wear-plate 116, rotating disc 112, top disc wear plate 114, and top seat disc 118, and the respective openings in flow path M-M in top plate 102 and bottom plate 104 thereby preventing ingress of material between any of the discs and plates 102, 104, 112, 114, 116, 118 and 120.

Further, as shown in FIG. 1, a vacuum can be applied to the valve. A vacuum hose (not shown) can be connected to coupling 192, where coupling 192 is located at hole 190 in bottom plate 104, and fixed by means such as bolts and sealed by means such as a gasket. A vacuum can be applied to facilitate operation in a process under vacuum as well as enabling cleaning of the valve to be performed by removing any foreign matter in the valve by applying a vacuum.

As shown in FIG. 3, the rotating disc 112 (and corresponding top disc wear plate 114 and floating disc wear plate 116) has, in effect, six operating positions per revolution of the rotating disc 112. Holes 122 provide three valve open positions, and the mass in between each hole, closure surface(s) 123, providing three alternate valve closed positions. It is to be appreciated that the respective rotating disc 112, top disc wear plate 114 and floating disc wear plate 116 can have any number of holes formed therein and an according number of operating positions. For example, in one embodiment a valve comprises two holes facilitating four operating positions (two open, two closed) per one rotation of rotating disc 112. In another embodiment, a valve comprises four holes facilitating eight operating positions (four open, four closed) per one rotation of rotating disc 112. It is to be appreciated that any number of holes can be formed into the rotating disc 112 (and corresponding top disc wear plate 114 and floating disc wear plate 116), however due consideration is to be given to the diameter of the hole(s) and the closure surface(s) area with respect to the diameter of the inlet 106 hole, outlet 107 hole and amount of feedstock to be passed through the valve for a given amount of time (e.g., the capacity of the valve).

When a valve is employed in an intermittent operation, with a valve closure surface 123 being located in the material flow path, e.g., between valve inlet 106 and valve outlet 107, feedstock collects against the closure surface 123. As the rotating disc 112 rotates to the “open” position, one of the plurality of holes 122 moves into alignment with the material flow path M-M, allowing the feedstock to pass through the valve, across valve inlet 106 and valve outlet 107. At the end of a feedstock transport operation, the rotating disc 112 further rotates until the next valve closure surface 123 (e.g., of top disc wear plate 114) is located in the material flow path M-M, between the valve inlet 106 and valve outlet 107, thereby preventing flow of material through the valve.

In another embodiment, as mentioned previously, a valve can be operated in any desired alignment, e.g., with the material flow path M-M orientated vertically, horizontally, etc. To facilitate the range of operating alignments, a valve can be operated in a state of suspension. For example, eyebolts 150 can be employed to allow the valve to be supported therefrom. Note, while only four eyebolts 150 are shown in FIGS. 1 and 2 (the fourth eyebolt is partially or totally obscured from view), any suitable number of eyebolts 150 can be employed. Furthermore, a valve can be designed such that components comprising the valve are designed and assembled to facilitate a valve with a center of gravity at the mid point of the valve assembly.

In another aspect, a valve can be employed in a process operating under a plurality of conditions where the combination of conditions has to be satisfied. For example, as mentioned previously, a valve can be employed in a process producing syngas from biomass. A valve can be employed at any suitable location in the process, e.g., to control feedstock being introduced into a high pressure and temperature reactor. High pressure and temperature can be employed in the production of syngas. The feedstock can comprise ash produced from a prior syngas operation, whereby the ash comprises of abrasive material. Accordingly, the valve and various components comprising the valve, can be manufactured from materials facilitating operation at elevated temperature, high pressure and with abrasive materials.

To further facilitate understanding of various components comprising a valve and their operation, FIG. 6 illustrates an exemplary, non-limiting schematic representation of a valve with a sectional view along S-S of FIG. 2. To facilitate material flow along flow path M-M respective holes 122 of the rotating disc 112, top disc wear plate 114, and floating disc wear plate 116 are brought into alignment with the respective fixed holes 138 of top seat disc 118 and floating seat disc 120. As shown in FIG. 6, the respective holes 122 and 138 are in alignment with holes formed in top plate 102 and bottom plate 104. The fixed holes 138 are kept in alignment with the holes formed in the top plate 102 and bottom plate 104 by tongue 126 and groove 127 arrangements. The collective alignment of respective holes 122 of the rotating disc 112, top wear disc plate 114 and floating disc wear plate 116 is maintained by tongue 124 and groove 125 arrangements. Rotation of the rotating disc 112, top wear disc plate 114 and floating disc wear plate 116 is effected by motor 140, via drive shaft 132, pinion gear 134, and a rack gear (see FIG. 1, gear 135) running around the circumference of rotating disc 112, where rotation alternately aligns a hole 122 with holes 138 during valve opening, and aligns a closure surface 123 with holes 138 during valve closure.

As previously described, during rotation of rotating plate 112, top wear disc plate 114, and floating disc wear plate 116, the positions of top seat disc 118 and floating seat disc 120 remains fixed. During operation of the valve a plurality of springs 142 provide compressive force against floating seat disc 120, whereon the compressive force is further transferred to floating disc wear plate 116, rotating disc 112, top disc wear plate 114 and top seat disc 118. Application of compressive force from springs 142 across the respective plates and discs 112, 114, 116, 118 and 120 ensures the plates and discs 112, 114, 116, 118 and 120 are pressed against the top plate 102 thereby preventing material being transported along flow path M-M from ingressing between each of the respective plates and discs 112, 114, 116, 118 and 120. In effect, the compressive force on the respective plates and discs 112, 114, 116, 118, and 120 acts to combine the respective plates and discs 112, 114, 116, 118, and 120 to function as being composed of a single block of material as opposed to five separate plates and/or discs.

Pivot shaft 128 is locked to rotating disc 112 by one or more keyway/key arrangements (not shown) and, accordingly, as rotating disc 112 is rotated a corresponding rotation of pivot shaft 128 is effected. Position of holes 122, and correspondingly closure surfaces 123, is determined by signals generated by proximity sensors 130 in accord with the position of indexes 180 and 181 of pivot shaft 128. The signals from the proximity sensors 130 are received by controller 610 which, based in part, on the signals received from the proximity sensors 130 controls motor 140. Where the valve is determined to be in a closed position (e.g., a closure surface 123 is closing flow path M-M) motor 140 is activated (e.g., by controller 610) thereby transmitting drive to drive shaft 132 which in accord with the effected rotational components as described above, pivot shaft 128 rotates. Once indexes 180 and 181 are correctly aligned (e.g., holes 122 are aligned with fixed holes 138 and flow path M-M is open) drive of drive shaft 132 is ceased. The process repeats as each respective closure surface 123 and holes 122 are brought in alignment with the fixed holes 138 resulting in respective closure and opening of the valve. Where a system comprising of three holes 122 and three closure surfaces 138, as indicated on FIG. 3, rotation of the rotating disc 112, top disc wear plate 114 and floating disc wear plate 116 requires 60 degree rotations between transitioning from an open valve state to a closed valve state.

It is to be appreciated that over the course of operation (e.g., from general wear or wear exacerbated with operation with an abrasive feedstock) rather than having to replace the complete valve, the only components that are to be replaced on a regular basis are the top disc wear plate 114, floating disc wear plate 116, top seat disc 118, and floating seat disc 120.

During operation of a valve, depending upon the material being flow controlled by the valve, wear of various components comprising a valve can occur. For example, during passage of abrasive material along flow path M-M, at least any of the following components may undergo wear: 112, 114, 116, 118, and/or 120. Of benefit is the option to determine the degree of wear undergone by one or more components comprising a valve, without having to disassemble the valve. In an embodiment, a valve can be configured such that wear encountered on 112, 114, and/or 118 can be determined without having to dismantle the valve.

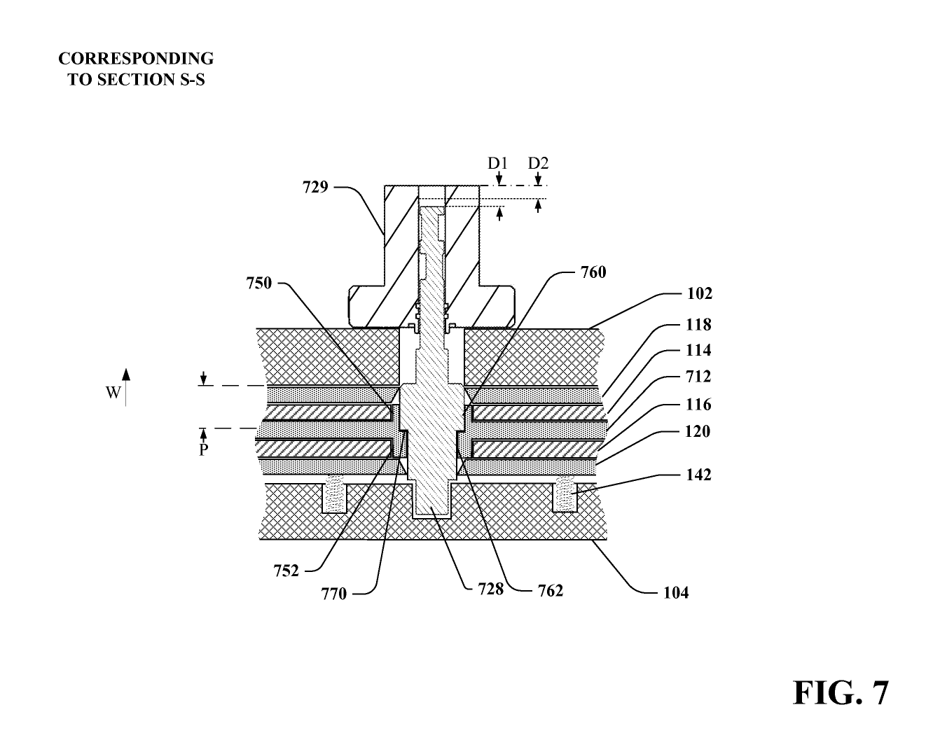

FIG. 7 is an exemplary, non-limiting illustration of an embodiment for monitoring wear of various valve components. FIG. 7 presents a sectional view corresponding to S-S of FIG. 2, showing the top plate 102 and bottom plate 104, with various plates and discs located therebetween rotating about pivot shaft 728. Pressure is being applied to floating seat disc 120 by a plurality of springs 142. Rotating disc 712 is located on pivot shaft 728 by an arrangement of a thinner section 750 and thicker section 752 of rotating disc 712 being respectively located on larger diameter 760 and smaller diameter 762 of pivot shaft 728. The respective large/small diameter holes (created by thinner section 750 and thicker section 752) locate in place on the respective larger diameter 760 and smaller diameter 762 sections of pivot shaft 728 creating a stepped profile as indicated at 770.

As described previously, springs 142 are employed to apply pressure on the floating seat disc 120 which, via floating disc wear plate 116, accordingly transfers pressure to rotating disc 712 which owing to the stepped profile at 770 transfers pressure to the pivot shaft 728. As the respective discs wear, e.g., top disc wear plate 114 and top seat disc 118, the position P (e.g., centerline) of rotating disc 712 will, under the influence of springs 142, move towards plate 102 as top disc wear plate 114 and top seat disc 118 become thinner owing to the effects of wear. Accordingly, the change in position of rotating disc 712 will cause the end of the pivot shaft 728 to move from position D1 to D2. Cap 729 can be manufactured to enable access to the end of pivot shaft 728 and any displacement in the location of the pivot shaft, e.g., D1 to D2, can be measured and the degree of wear, for example of top disc wear plate 114 and top seat disc 118, to be determined. Measurement of the difference in position between D1 and D2 can be performed using any displacement measuring device such as a depth micrometer. Hence, rather than having to dismantle a valve for wear of respective discs and plates (e.g., 112, 114, 116, 118, and 120) to be determined, it is possible to gain a measure of the degree of wear by measuring the displacement of the pivot shaft 728.

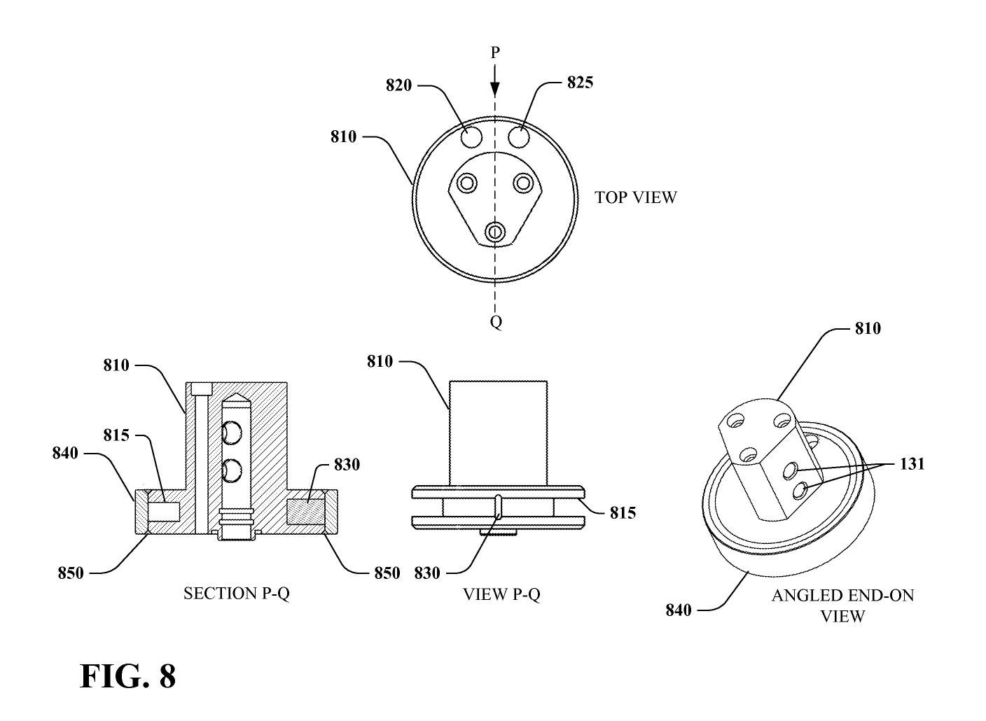

FIG. 8 is an exemplary, non-limiting illustration of an embodiment for cooling various valve components. FIG. 8 presents four alternative views of an embodiment facilitating cooling of a cap 810. It is to be appreciated that cap 810 provides similar functionality to that provided by caps 129 and 729, previously discussed with reference to at least FIGS. 1, 2, and 4-7. As shown in FIGS. 6 and 7 pivot shaft 128 or 728 extends into cap 129 or 729 thereby acting as a heat path for heat from the various discs and wear plates 112, 114, 116, 118, and 120, being conveyed to the vicinity of proximity sensors 130. To minimize the heat effects caps 129 or 729 can be cooled, as shown in an embodiment with cap 810. FIG. 8, Top View, indicates the location of coolant inlet hole 820 and coolant outlet hole 825. To provide a cooling channel around the cap 810, a sleeve 840 is located around the bottom of the cap 810, wherein the cap 810 has groove 815 machined into the circumference, and a cooling channel is formed between the groove 815 and the sleeve 840. Further, to facilitate directional flow of the coolant through the cooling channel formed between the groove 815 and the sleeve 840 a baffle 830 is inserted in the groove 815 between the respective location of coolant inlet hole 820 and coolant outlet hole 825, as shown in FIG. 8, View P-Q and FIG. 8, Section View P-Q. Accordingly, coolant enters the cooling channel via coolant inlet hole 820, navigates the cooling channel and exits the cooling channel via coolant outlet hole 825. The passage of coolant through the coolant channel facilitates cooling of the cap 810 and thereby, minimizes heat affecting proximity sensors 130. As shown by fillets 850, the respective mating corners of cap 810 and 840 can be chamfered to facilitate sealing of the cooling channel by brazed fillets, welded fillets or other suitable means for ensuring sealing of the cooling channel.

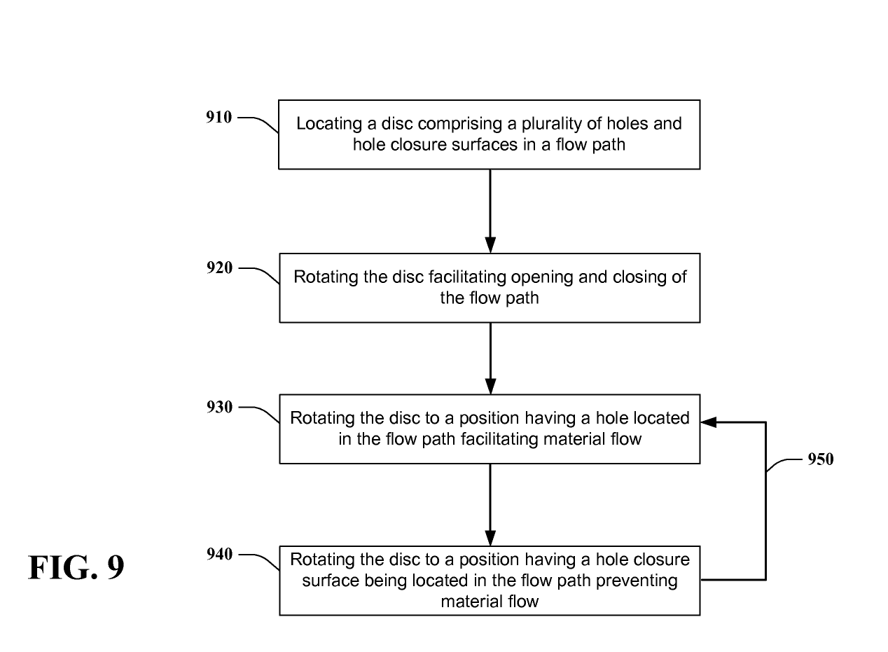

FIG. 9 presents a flow diagram illustrating an exemplary, non-limiting approach for controlling flow of material along a flow path in accordance with one or more embodiments. At 910 a disc comprising a plurality of holes and hole closure surfaces is located in a material flow path, wherein the disc is located on a pivot shaft facilitating rotation of the disc in relation to the material flow path. In an embodiment, the material flow path can comprise of a valve inlet and a valve outlet, wherein, during a state of valve open, a hole in the disc is located in the material flow path enabling material to flow from the valve inlet to the valve outlet. To close the valve the disc is rotated such that a closure surface is located between the valve inlet and the valve outlet thereby interrupting flow of material along the material flow path. It is anticipated that during initialization of a process in which the various innovative aspects disclosed herein is employed, the disc is initially positioned such that a closure surface is placed in the material flow path thereby preventing material flow along the material flow path until the process has reached desired operating conditions. However, it is to be appreciated that the disc can be located at any rotational position with regard to hole/closure surface position with respect to the material flow path.

At 920 the current position of the disc is determined, e.g., by a controller, based upon a position of at least one index. In an embodiment, the at least one index is located on the pivot shaft and the at least one index indicates respective positions of holes or closure surfaces comprising the disc. In an embodiment a plurality of indexes can be utilized where each index comprises a plurality of surfaces, with each surface corresponding to a hole in the disc or a disc closure surface. In an embodiment, by reading the position of at least one index in relation to a sensing device, the current position of the disc can be determined. For example, whether a hole is located in the material flow path, a closure surface is located in the material flowpath, or the disc is positioned at an intermediate state such as valve half open, valve quarter open, etc. As mentioned with regard to act 910, during installation of the valve, and or initial process startup, it is possible that the valve is in a closed position to prevent material flow along the flow path.

At 930 the disc is rotated to a position whereby a hole in the disc is aligned with the material flow path thereby allowing material to flow. In an embodiment, rotation of the disc is facilitated by a motor and geared drive meshing with a gear teeth running along the circumferential edge of the disc. The type of gearing employed can be helical, double helical, spur, etc. Rotation of the geared drive by the motor transmits rotational motion to the disc, causing the disc to rotate. In an embodiment where the valve is initially installed with a disc closure surface preventing flow of material along the material flow path, the disc is rotated such that a hole in the disc is located in the material flow path, thereby allowing flow of material along the material flow path. To determine the rotational position of the disc and respective holes and closure surfaces positional feedback is obtained from the indexes, e.g., by the controller. Once the disc is located as required, e.g., a hole is located in the material flow path, operation of the motor is ceased.

At 940 material flow is to be discontinued. Operation of the motor is recommenced (e.g., by the controller) which, via the geared drive, transmits rotational drive to the disc. Accordingly, the disc is rotated until readings from the at least one index indicate that a closure surface is positioned in the flow path thereby preventing material flow beyond the valve. Once the closure surface is at the required location, e.g., material flow is terminated, rotational drive of the disc by the motor is ceased. At 950, acts 930 and 940 are repeated as required to facilitate material flow and cessation of material flow during operation of the process in which the rotating disc is being employed to control.

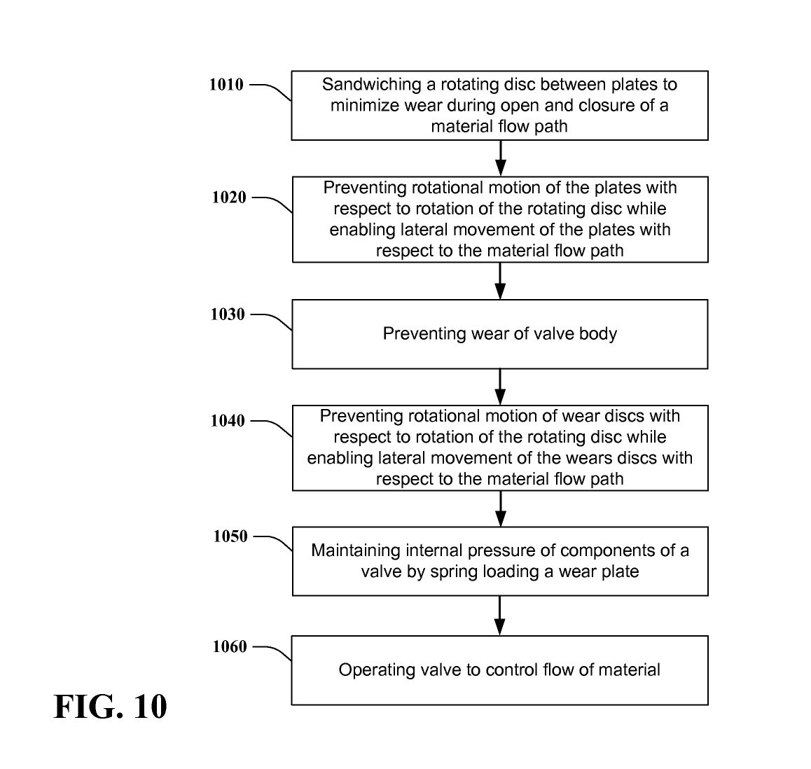

FIG. 10 presents a flow diagram illustrating an exemplary, non-limiting embodiment for maintaining internal pressure during operation of a valve, wherein control of material flow through the valve is performed by a rotating disc comprising at least one hole and at least one closure surface. Of concern during operation of a valve utilizing rotation of a disc to respectively open and close a material flow path by means of hole(s) and closure surface(s) respectively across a flow path is prevention of material ingres sing between various component surfaces comprising the valve, thereby reducing the effectiveness of valve operation and possible failure of the valve. Further, to facilitate operation of the valve it is desired to construct the valve from components which will have extended usage while enabling replacement of components which, during operation of the valve, may undergo wear. It is to be appreciated that while the two concepts are addressed here in a single methodology the concepts of part replacement owing to wear and prevention of material ingress can be employed in separate and distinct embodiments. During operation of a valve the top and bottom surfaces of the rotating disc, during rotation of the rotating disc, can wear against the inner surfaces of the valve body. At 1010 prevention of wear to the rotating disc is achieved by sandwiching the rotating disc between a floating disc wear plate and a top disc wear plate. Accordingly, the surfaces of the rotating disc, which were previously exposed and susceptible to wear are now covered by respective plates which are designed to wear and are replaceable.

During course of operation of the valve, e.g., during rotational motion of the rotating disc and the floating disc wear plate and top disc wear plate, the floating disc wear plate and the top disc wear plate are susceptible to wear. For optimal operation both the floating disc wear plate and the top disc wear plate should remain fixed to the rotating disc and unable to move in relation to the rotating disc in the direction of rotation of the rotating disc. However, to facilitate removal of one or both of the floating disc wear plate or the top disc wear plate from the rotating disc, where removal can be, in an embodiment, required owing to either or both of the floating disc wear plate and top disc wear plate being worn, it is beneficial that the floating disc wear plate and top disc wear plate can move laterally with respect to the direction of material flow through the valve, e.g., a direction perpendicular to the plane of rotation of the rotating disk. At 1020, in an embodiment, a plurality of tongue and groove arrangements are employed to locate a wear plate to the rotating disc. A plurality of tongues are located around an internal periphery of the rotating disc. An according number of grooves are formed in the wear plate, wherein the number of grooves and their location matches with the number and location of tongues located on the rotating disc. Further, the wear plate comprises holes and closure surfaces arranged to match the holes and closure surfaces of the rotating disc. Locating a wear plate on the rotating disc using the tongue and groove arrangement enables rotational movement of the wear plate to be minimized with regard to rotational movement of the rotating disc. Accordingly, alignment of holes and closure surfaces between the respective rotating disc and floating disc wear plate and top disc wear plate are maintained. Locating a wear plate on the rotating disc using the tongue and groove arrangement enables the wear plate to be free to move in the lateral direction, e.g., perpendicular to the rotational direction of the rotating disc, thereby allowing the wear plate to wear and at the same time enabling ease of separation of a wear plate from the rotating disc, e.g., for maintenance or replacement of a wear plate. Hence, the wear plates are sacrificial means for preventing wear of the rotating disc. During operation of the valve, e.g., while the rotating disc rotates from sequential open and closed positions, wear is confined to wear of the wear plates, not the rotating disc.

During rotation of the rotating disc (and located floating disc wear plate and top disc wear plate) wear of the internal surfaces of the valve body can occur. At 1030, a floating seat disc is positioned to separate the inner outlet-side surface of the valve housing from the floating disc wear plate located on the rotating disc, thereby preventing wear of the inner outlet-side surface of the valve housing. The floating seat disc comprises a hole which is to be aligned with the valve outlet hole. Correspondingly, during rotation of the rotating disc, wear can occur between the top disc wear plate located on the rotating disc and the opposing inner surface of the valve housing. A top seat disc is located on the valve housing inlet-side inner surface of the valve housing, separating the valve housing inlet-side inner surface from the top disc wear plate, thereby preventing wear of the valve housing by the top disc wear plate. The top seat disc comprises a hole which is to be aligned with the valve inlet hole.

As previously described, during operation of the valve the rotating disc, top disc wear plate and floating disc wear plate rotate facilitating sequential respective location of a hole and a closure surface in the material flow path, thereby controlling flow of material along the flow path. The rotational movement of the rotating disc, top disc wear plate and floating disc wear plate can transfer rotational movement respectively to the top seat disc and the floating seat disc. Rotational movement of either of the top seat disc and/or the floating seat disc can result in misalignment of the hole formed therein in relation to the respective valve inlet and valve outlet holes, as well as causing wear to the inner outlet-side surface of the valve housing and valve housing inlet-side inner surface. At 1040, tongue and groove arrangements are employed between the top seat disc and the valve housing inlet-side inner surface, and the floating seat disc and the inner outlet-side surface of the valve housing. Similar to the tongue and groove arrangements employed at 1020, the tongue and groove arrangements prevent rotational movement of the top seat disc and the floating seat disc, while facilitating lateral movement of the discs in the direction of the material flow path, e.g., perpendicular to the to rotational direction of the rotating disc.

At 1050, to facilitate operation of the valve it is desired to minimize material ingressing between the respective plates and discs comprising a valve arrangement as described in acts 1010-1040. To maintain pressure on the respective plates and discs pressure is applied to the floating seat disc. Compressive force, e.g., by springs, can be applied to floating seat disc which transfers the compressive force to the floating disc wear plate, rotating disc, top disc wear plate and top seat disc thereby in effect combining the respective plates and discs to function as being comprised of a single block of material as opposed to five separate plates and/or discs and, accordingly, preventing ingress of material between any two plates and/or discs. Furthermore, a valve can be operated in a plurality of orientations, e.g., vertically, horizontally, 45° angle, etc. To facilitate correct performance of the valve the spring loaded floating seat disc can be employed to maintain compressive loading of other components comprising the valve (e.g., rotating disc, wear plates, etc.). For example, if a valve is orientated vertically to a feed path flowing therethru (e.g., feed path M-M) the various components comprising the valve will be affected by the forces of gravity and accordingly drop to the bottom of the valve which can cause poor operation of the valve. For example, the various components will only be operating in accordance with their mass. Such operation can cause material to ingress between the various plates and cause the plates to separate which can lead to poor operation of the valve. To compensate for such operation, pressure can be exerted on the various plates by the spring loaded wear plate. Such operation results in the various components being kept in a state of compression, e.g., packing of the respective plates and discs, thereby preventing ingress of material between any two plates and/or discs a regardless of valve orientation.

At 1060 operation of the valve is commenced whereby the rotating disc is rotated from a position of valve closed to a position of valve open, as described above. The combination of sandwiching the rotating disc between a top disc wear plate and a floating disc wear plate, and separating the top disc wear plate and the floating disc wear plate from the inner surfaces of the valve body housing with respective top seat disc and floating seat discs along with applying compressive force to the stack of discs and plates enables the valve to operate with wear being confined to components designed for ease of replacement while ingress of material between a respective plate and/or disc is negated thereby reducing the wear of the plates and discs during rotation of the rotating disc.

During operation of a valve comprising a rotating disc to facilitate open and closure of a material flow path, wear of respective components comprising the valve can occur. The wear process can be exacerbated by passing abrasive material through the valve. FIG. 11 presents a flow diagram illustrating an exemplary, non-limiting embodiment facilitating determination of wear to components comprising a valve without having to dismantle the valve. At 1110 a datum position is established with respect to the position of the rotating disc of the valve. As described previously, the rotating disc is located on a pivot shaft, where the pivot shaft extends into the top plate of the valve and a cap located externally on the top plate. During initial assembly of the valve, the rotating disc is sandwiched between a top disc wear plate and a floating disc wear plate, whereupon the disc/plate sandwich is position between a top seat disc and a floating seat disc. The disc/plate sandwich, top seat disc, and floating seat disc are located inside the valve housing under compressive pressure. Upon completion of assembly of the valve the position of the rotating disc is at a fixed position as a result of the thicknesses of the various plates and discs comprising the valve assembly and the compressive force being applied thereto. For example, the position of the centerline of the rotating disc with respect to the inner surface of the top plate is a function of the thickness of the top seat disc, the top disc wear plate, and the rotating disc. As previously mentioned, the rotating disc is located on the pivot shaft. The pivot shaft extends out from the top plate and into the cap. By incorporating an access hole into the end of the cap, the position of the pivot shaft can be employed to determine the position of the rotating disc and accordingly the degree of wear of the top disc wear plate and the top seat disc.

At 1120 for a particular valve assembly the position of the end of the pivot shaft is measured. Measurement can be by any suitable means, such as using a depth micrometer to determine the position of the end of the pivot shaft versus the end of the cap within which the pivot shaft is located.

At 1130 the valve is operated, whereby the rotating disc is sequentially moved from a valve open position to a valve closed position, etc.

At 1140, at any desired time during operation of the valve a new datum position can be determined by measuring the current position of the end of the pivot shaft in relation to the end of the cap.

At 1150 the amount of shift in the position of the end of the pivot shaft can be determined between the original position of the end of the pivot shaft and the currently measured position. The amount of shift in the position of the end of the pivot shaft is an indication of the degree of wear affecting the top disc wear plate and the top seat disc. Based upon the amount of wear a determination as to the amount of wear undergone by components comprising the valve can be made and whether the amount is acceptable.

At 1160, if the amount of wear is acceptable operation of the valve recommences with methodology 1100 recommencing from act 1130.

At 1170, if the amount of wear is deemed to be unacceptable, operation of the valve is ceased.

At 1180, depending upon how the valve is being employed, in an embodiment, the valve assembly can be dismantled and the respective worn components can be inspected and, if necessary, replaced with new components, e.g., a new top seat disc and a new top disc wear plate.

At 1190, upon reassembly of the valve, methodology 1100 can recommence from act 1120 with a new datum position being determined for the end of the pivot shaft and accordingly the position of the rotating disc.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

In view of the exemplary systems described supra, methodologies that may be implemented in accordance with the described subject matter can also be appreciated with reference to the flow diagrams of the various figures. While for purposes of simplicity of explanation, the methodologies are shown and described as a series of blocks or acts, it is to be understood and appreciated that the various embodiments are not limited by the order of the blocks, as some blocks may occur in different orders and/or concurrently with other blocks from what is depicted and described herein. Where non-sequential, or branched, flow is illustrated via a flow diagram, it can be appreciated that various other branches, flow paths, and orders of the blocks or acts, may be implemented which achieve the same or a similar result. Moreover, some illustrated blocks are optional in implementing the methodologies described herein.

In addition to the various embodiments described herein, it is to be understood that other similar embodiments can be used or modifications and additions can be made to the described embodiment(s) for performing the same or equivalent function of the corresponding embodiment(s) without deviating therefrom. Accordingly, the invention is not to be limited to any single embodiment, but rather is to be construed in breadth, spirit and scope in accordance with the appended claims.

What is claimed is:

1. A system for controlling flow of material through a valve, comprising:
a rotating disc comprising a plurality of holes and a plurality of closure surfaces separating the plurality of holes;
a drive to facilitate rotation of the rotating disc; and
a control to operate the drive to position one of a hole or a closure surface with respect to a valve flow path.

2. The system of claim 1, wherein rotation of the rotating disc locates the hole in the valve flow path to facilitate flow of material through the valve.

3. The system of claim 1, wherein rotation of the rotating disc locates the closure surface in the valve flow path to terminate flow of material through the valve.

4. The system if claim 1, further comprising a pivot shaft on which the rotating disc is located.

5. The system of claim 4, the pivot shaft further comprising at least one index to facilitate determination of whether the hole or the closure surface is located with respect to the valve flow path.

6. The system of claim 5, further comprising at least one proximity sensor to measure the position of the at least one index.

7. The system of claim 1, wherein the rotating disc is sandwiched between wear plates.

8. The system of claim 1, further comprising application of compressive force on the rotating disc to prevent ingress of material between an operating surface of the rotating disc and an opposing surface in contact with the operating surface of the rotating disc.

9. The system of claim 8, further comprising springs which apply compressive force to a plate acting as the opposing surface in contact with the operating surface of the rotating disc, wherein the plate transmits compressive force to the operating surface of the rotating disc.

10. A method for controlling flow of material through a valve, comprising:
rotating a disc across the flow path of the valve, wherein the disc further comprises a plurality of holes and closure surfaces.

11. The method of claim 10, further comprising rotating the disc such that a hole is located in the flow path of the valve facilitating flow of material along the flow path.

12. The method of claim 10, further comprising rotating the disc such that a closure surface is located in the flow path of the valve facilitating flow of material along the flow path.

13. The method of claim 10, further comprising determining position of at least one hole in the plurality of holes or at least one closure surface in the plurality of closure surfaces.

14. The method of claim 13, further comprising determining the position of the at least one hole in the plurality of holes or the at least one closure surface in the plurality of closure surfaces by monitoring a position of an index associated with the at least hole or the at least one closure surface.

15. The method of claim 14, further comprising rotating the disc in accordance with the position of the index facilitating positioning of the at least one hole in the plurality of holes or the at least one closure surface in the plurality of closure surfaces with respect to the flow path.

16. The method of claim 10, further comprising separating a surface of the rotating disc from an inner surface of the valve by a sacrificial wear plate.

17. The method of claim 16, further comprising determining wear of the sacrificial wear plate by measuring a position of the disc with respect to a datum associated with an external surface of the valve.

18. The method of claim 10, further comprising utilizing a pinion gear to mesh with a rack gear running around the circumference of the disc.

19. A system comprising:
means for controlling flow of material, further comprising:
a plurality of means for opening a flow path;
a plurality of means for closing a flow path; and
means for advancing the means for opening a flow path or the means for closing the valve path with a position respective to a flow path.

20. The system of claim 19, further comprising means for determining the position of the plurality of means for opening the flow path.
